(19) United States
(12) Patent Application Publication
(10) Pub. No.: US 2014/0158861 A1
(43) Pub. Date: Jun. 12, 2014

(54) PHOTOSENSITIVE INPUT DEVICE AND PHOTOSENSITIVE INPUT PANEL

(71) Applicants: Hong Fu Jin Precision Industry (ShenZhen) Co., Ltd., (US); HON HAI PRECISION INDUSTRY CO., LTD., New Taipei (TW)

(72) Inventors: KAI XU, Shenzhen (CN); HUI YIN, Shenzhen (CN); CHUN-WEI PAN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/873,119

(22) Filed: Apr. 29, 2013

(30) Foreign Application Priority Data
Dec. 7, 2012 (CN) 2012105217345

(51) Int. Cl. G01J 1/44

(52) U.S. Cl. CPC G01J 1/44
USPC 250/206

(57) ABSTRACT

A photosensitive input device includes a stylus, a photosensitive input panel including an induction layer, a photoelectric detecting circuit, a driving circuit, a controller, and a storage device. The induction layer includes a plurality of photosensitive units including a light-emitting element and a light-receiving element together. The photosensitive element outputs a current when struck by the light from the stylus, the current intensity being dependent on the wavelength of the emitted light. The photoelectric detecting circuit determines coordinates based on the induced current and the intensity of the induced current. The driving circuit generates a driving current or a reduced or a zero current in response, based on a pre-determined table and outputs the driving current to show the track of the stylus-light across the input panel, by illuminating the relevant light-emitting elements or by switching down or switching off the relevant light-emitting elements.

### CROSS-REFERENCE TO RELATED APPLICATIONS

Related subject matter is disclosed in co-pending U.S. patents application with an Attorney Docket Number US48712 and a title of PHOTOSENSITIVE INPUT-OUTPUT DEVICE AND PHOTOSENSITIVE INPUT-OUTPUT PANEL, which has the same assignees as the current application and was concurrently filed.

### BACKGROUND

1. Technical Field

The present disclosure relates to input devices and particularly to a photosensitive input device and a photosensitive input panel.

2. Description of the Related Art

LED display devices with touch screens are common, and such touch screens generally include a touch panel positioned over a LED display screen or a plurality of touch detecting elements integrated with the LED display screen, thus resulting in increased thickness of the LED display device as well as heat generation, and further decreasing the brightness of the display screen in the touch screens.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of a photosensitive input device according to an exemplary embodiment.

FIG. 2 is a schematic view of an induction layer of the photosensitive input device of FIG. 1.

FIG. 3 is a block diagram of the photosensitive input device of FIG. 1.

### DETAILED DESCRIPTION

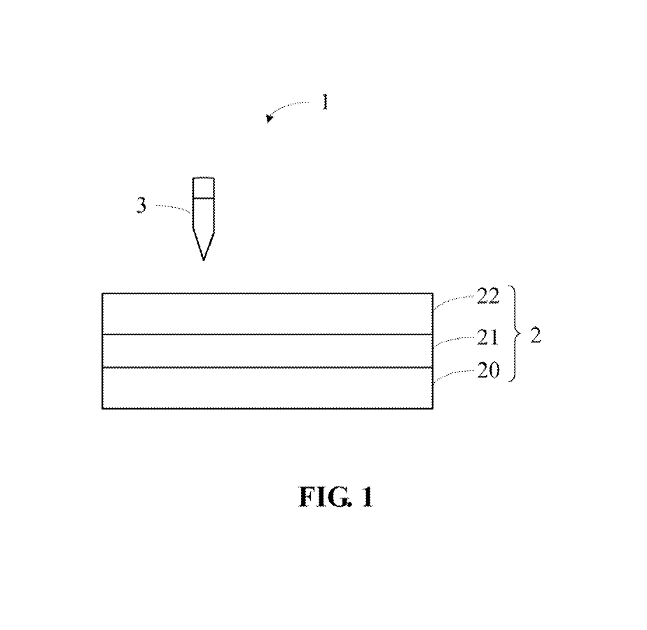

Referring to FIG. 1, a photosensitive input device 1 according to an exemplary embodiment includes a photosensitive input panel 2 and a stylus 3. The photosensitive input panel 2 includes a substrate 20, an induction layer 21, and a cover 22. The induction layer 21 is sandwiched between the substrate 20 and the cover 22. The stylus 3 emits lights with specific wavelengths.

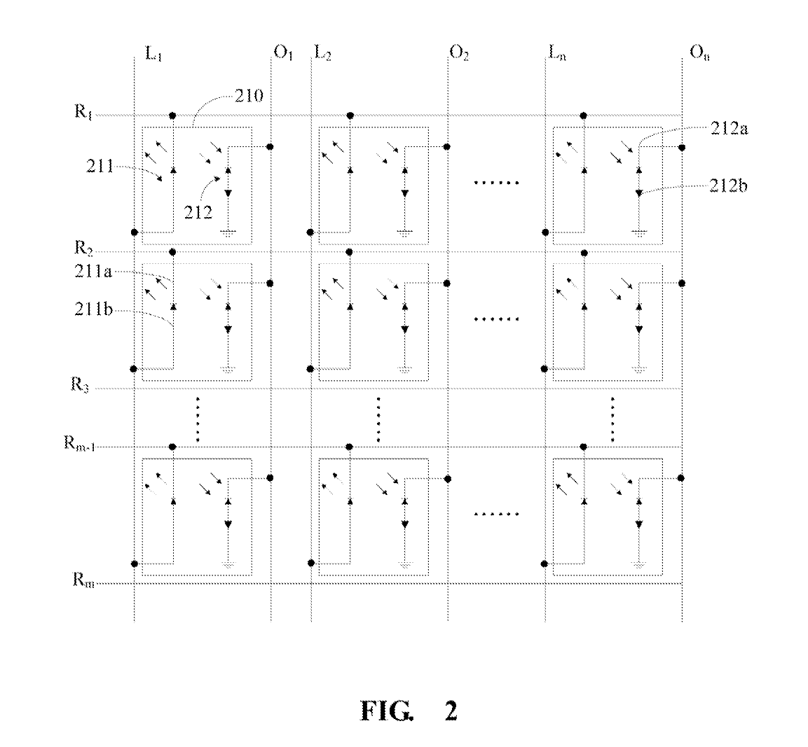

Referring to FIG. 2, the induction layer 21 includes m*n photosensitive units 210, where m, n are natural numbers. Each of the photosensitive units 210 includes a light-emitting element 211 and a photosensitive element 212 coupled with the light-emitting element 211. In the embodiment, the light-emitting element 211 is a light-emitting diode, the photosensitive element 212 is a photosensitive diode. Each light-emitting element 211 includes a first terminal 211 a and a second terminal 211b, and each photosensitive element 212 includes a first terminal 212a and a second terminal 212b. The first terminals 211 a of the light-emitting elements 211 in a single row are connected to a row wire Rᵢ. The second terminals 211b of the light-emitting elements 211 in a single column are connected to a column wire Lⱼ. The first terminals 212a of the photosensitive elements 212 of one column are connected together to form an output terminal Oⱼ. The second terminal 212b of each photosensitive element 212 is grounded, thus i=1, 2, . . . n, j=1, 2, . . . m.

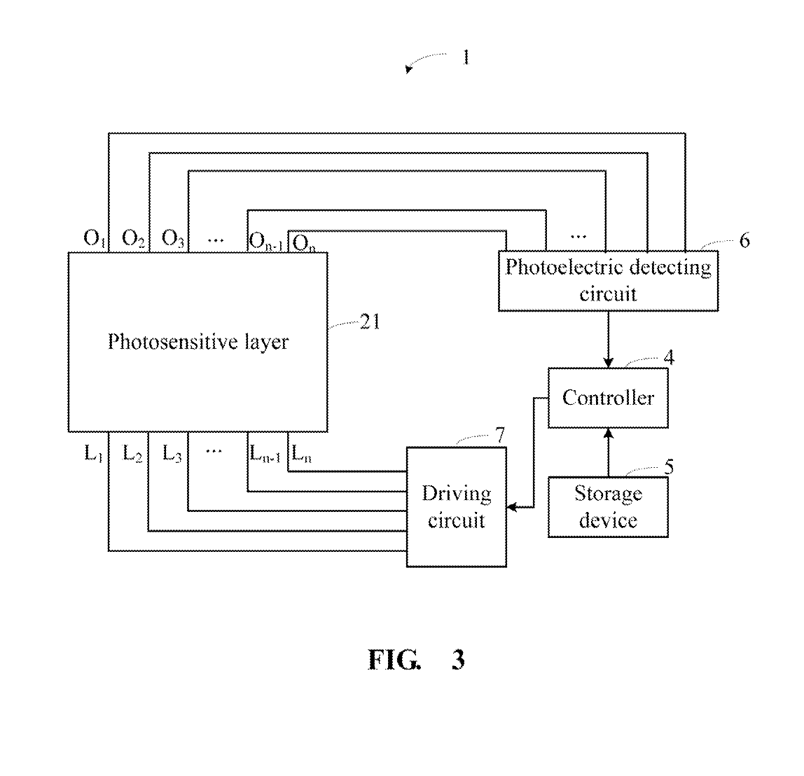

Referring to FIG. 3, the photosensitive input device 1 further includes a controller 4, a storage device 5, a photoelectric detecting circuit 6, and a driving circuit 7.

The storage device 5 is connected to the controller 4, and stores coordinates in the system of the panel 2. The photosensitive units 210 constitute the coordinates of the system of the panel 2, that is, the light-emitting element 211 and the photosensitive element 212 of each photosensitive unit 210 represent particular coordinates of the system of the panel 2.

The photoelectric detecting circuit 6 is connected to the photosensitive elements 212 via the output terminal Oᵢ. The stylus 3 is operable by user to emit light, when the light of the stylus 3 reaches one or more photosensitive elements 212 of the induction layer 21, each of the one or more photosensitive elements 212 senses the light to generate an induced current Iᵢ. The output terminal Oᵢ outputs the induced current Iᵢ to the photoelectric detecting circuit 6. The induced current Iᵢ precisely reflects the wavelength(s) of the light emitted by the stylus 3, where the induced current Iᵢ includes the intensity value of the induced current Iᵢ and the waveform of the induced current Iᵢ.

The photoelectric detecting circuit 6 is configured to determine which one of the photosensitive elements 212 generates the induced current Iᵢ, and therefore to determine the coordinates of the photosensitive element 212 that generates the induced current Iᵢ and the coordinate of the light-emitting element coupled with the photosensitive element 212, and is further configured to determine the intensity of the induced current Iᵢ.

The storage device 5 further stores a pre-defined table mapping a relationship between intensities of the inducted current Iᵢ and brightness levels of the light-emitting elements 211. The controller 4 determines the desired brightness level according to the pre-determined table and the intensity of the induced current Iᵢ as determined by the photoelectric detecting circuit 6. The driving circuit 7 is connected to the light-emitting elements 211 via the column wire Lᵢ, and configured to generate driving current in response to the desired brightness level determined by the controller 4, determine the column wire Lᵢ according to the coordinates of the photosensitive elements 212 determined by the photoelectric detecting circuit 6, and further configured to output the driving current to the light-emitting elements 211 which are coupled with the photosensitive elements 212 via the determined column wire Lᵢ for adjusting the brightness of the light-emitting elements 211. Thus, if the stylus 3 emits light with a specific wavelength along a specific track across the panel 2, the light-emitting elements 211 on the specific track are highlighted and the brightness of the light-emitting elements 211 is adjusted in response to the user command, the specific track being visible on the panel 2.

For example, if the stylus 3 emits light with a first wavelength which strikes the panel 2 along a specific track, the photosensitive elements 212 illuminated thereby generate a first induced current. The controller 4 determines the user command to be turn on the light-emitting elements 211 or increase the brightness of the light-emitting elements 211, according to the pre-determined table and the intensity of the first induced current, and generates a corresponding first control signal. The driving circuit 7 turns on the light-emitting elements 211 or increases the brightness of the light-emitting elements 211 to correspond to the first control signal, which results in the specific track being displayed. If the stylus 3 emits light with a second wavelength which illuminates the panel 2 along the specific track, the photosensitive elements 212 illuminated thereby generate a second induced current. The controller 4 determines the command to be turn off the light-emitting elements 211 or decrease the brightness of the light-emitting elements, according to the pre-determined table and the intensity of the second induced current, and generates a corresponding second control signal. The driving circuit 7 thereby turns off the light-emitting elements 211 or decreases the brightness of the light-emitting elements 211 to correspond to the command determined by the controller 4, which results in the specific track being unlit or having a decreased brightness.

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. A photosensitive input device, comprising:
a stylus operable to emit light beams;
a photosensitive input panel comprising:
an induction layer comprising:
a plurality of photosensitive units arranged in matrix, each of the plurality of photosensitive units comprising:
a light-emitting element comprising a first terminal and a second terminal, the first terminals of the light-emitting elements arranged at a same row connected to a row wire, the second terminals of the light-emitting elements arranged at a same column connected to a column wire, and the light-emitting element representing a particular coordinate of a coordinate system of the panel; and
a photosensitive element coupled with the light-emitting element and corresponding to the particular coordinate, the photosensitive element comprising a first terminal and a second terminal, the first terminals of the photosensitive elements arranged at a same column connected together to form an output terminal, the second terminal of each photosensitive element grounded, the photosensitive element configured to generate an induced current when senses the light beams from the stylus, the output terminal configured to output the induced current;
a storage device configured to store a pre-defined table recording mapping relationship between intensities of the induced current and commands of controlling the light-emitting elements;
a photoelectric detecting circuit connected to the output terminals of the photosensitive elements, and configured to determine the coordinate of the photosensitive element that generates the induced current and the coordinate of the light-emitting element coupled with the photosensitive element, and further configured to determine the intensity of the induced current;
a controller configured to determine the command according to the pre-determined table and the intensity of the induced current determined by the photoelectric detecting circuit; and
a driving circuit connected to the column wires, and configured to generate driving current in response to the command determined by the controller, determine the column wire according to the coordinates of the photosensitive elements determined by the photoelectric detecting circuit, and further configured to output the driving current generated to the light-emitting elements coupled with the photosensitive elements determined via the determined column wire for controlling the light-emitting elements.

2. The photosensitive input device as recited in claim 1, wherein controlling the light-emitting elements comprises adjusting the brightness of the light-emitting elements.

3. The photosensitive input device as recited in claim 1, wherein the photosensitive input panel further comprises a substrate and a cover, and the induction layer is sandwiched between the substrate and the cover.

4. The photosensitive input device as recited in claim 1, wherein the induced current precisely reflects the wavelength of the lights emitted by the stylus.

5. The photosensitive input device as recited in claim 4, wherein the induced current comprises the intensity value of the induced current and the waveform of the induced current.

6. A photosensitive input panel comprising:
a substrate; and
an induction layer disposed on the substrate, the induction layer comprising a plurality of photosensitive units arranged in matrix, each of the photosensitive units comprising a light-emitting element and a photosensitive element coupled with the light-emitting element, the photosensitive element being operable to generate an induced current when sensing light beams from a stylus, each photosensitive element connected to an output terminal configured to output the induced current, and each light-emitting element connected to a column wire which is configured to input a driving current generated in response to the induced current to control the light-emitting element.

7. The photosensitive input panel as recited in claim 6, wherein controlling the light-emitting elements comprises adjusting the brightness of the light-emitting elements.

8. The photosensitive input panel as recited in claim 6, wherein each light-emitting element comprises a first terminal and a second terminal, the first terminals of the light-emitting elements arranged at a same row connected to a row wire, the second terminals of the light-emitting elements arranged at a same column connected to the column wire; each photosensitive element coupled with the light-emitting element and corresponding to the particular coordinate, the photosensitive element comprises a first terminal and a second terminal, the first terminals of the photosensitive elements arranged at a same column connected together to form the output terminal, and the second terminal of each photosensitive element is grounded.

9. The photosensitive input panel as recited in claim 6, further comprising a cover disposed on the induction layer.

10. The photosensitive input panel as recited in claim 6, wherein the induced current precisely reflects the wavelength of the lights emitted by the stylus.

11. The photosensitive input panel as recited in claim 10, wherein the induced current comprises the intensity value of the induced current and the waveform of the induced current.

12. A photosensitive input panel comprising:
a substrate; and
an induction layer disposed on the substrate, the induction layer comprising:
a plurality of photosensitive units arranged in matrix, each of the plurality of photosensitive units comprising:
a photosensitive element coupled with the light-emitting element and corresponding to the particular coordinate, the photosensitive element comprising a first terminal and a second terminal, the first terminals arranged at a same column connected together to form an output terminal, each second terminal being grounded, the photosensitive element configured to generate an induced current when sensing the light beams from the stylus, the output terminal configured to output the induced current; and
a light-emitting element comprising a first terminal and a second terminal, the first terminals arranged at a same row connected to a row wire, the second terminals arranged at a same column connected to a column wire, the column wire configured to input a driving current generated in response to the induced current to adjust the brightness of the light-emitting element.

13. The photosensitive input panel as recited in claim 12, further comprising a cover disposed on the induction layer.

14. The photosensitive input panel as recited in claim 12, wherein the induced current precisely reflects the wavelength of the lights emitted by the stylus.

15. The photosensitive input panel as recited in claim 14, wherein the induced current comprises the intensity value of the induced current and the waveform of the induced current.
